(19) United States
(12) Patent Application Publication
(10) Pub. No.: US 2005/0254544 A1
(43) Pub. Date: Nov. 17, 2005

(54) Gas-tight electrode for carbothermic reduction furnace

(75) Inventor: Johann Daimer, Morfelden-Walldorf (DE)

Correspondence Address: LERNER AND GREENBERG, PA, P O BOX 2480, HOLLYWOOD, FL, 33022-2480, US

(73) Assignee: SGL Carbon AG

(21) Appl. No.: 11/123,774

(22) Filed: May 5, 2005

Related U.S. Application Data
(60) Provisional application No. 60/571,058, filed on May 14, 2004.

(51) Int. Cl. H05H 1/00; H05B 7/00

(52) U.S. Cl. 373/18; 373/75; 373/88

(57) ABSTRACT

A graphite electrode for an electrothermic reduction furnace in which aluminum is produced by carbothermic reduction of alumina is rendered substantially gas-impermeable. The graphite electrode is consumed during furnace operation and electrode columns connected by graphite pins are fed continuously fed in from the top into the furnace. The coating of the electrode withstands a temperature of up to 300° C. and more over a period of several hours without oxidation. Since the coating enters the furnace compartment at least partially, it is configured so that it will not contaminate the hot melt. That is, the chemistry of the coating materials is similar to 1o the ingredients of the overall reaction or, at a minimum, the amount of foreign elements is very low. The coating is provided so that it does not increase the electrical contact resistance at the connection between the electrode columns and the electrode holding clamps. Where the electrode inlet area is cooled by water, the coating is insoluble in water.

### CROSS-REFERENCE TO RELATED APPLICATION

This application claims the benefit under 35 U.S.C. § 119 (e), of copending U.S. Provisional Application No. 60/571,058, filed May 14, 2004.

### BACKGROUND OF THE INVENTION

1. Field of the Invention

The present invention relates to electrodes made of graphite for the production of aluminum by the carbothermic reduction of alumina.

2. Description of the Related Art

For a century the aluminum industry has relied on the Hall-Heroult process for aluminum smelting. In comparison with processes used to produce competing materials, such as steel and plastics, the process is energy-intensive and costly. Hence, alternative aluminum production processes have been sought.

One such alternative is the process referred to as direct carbothermic reduction of alumina. As described in U.S. Pat. No. 2,974,032 (Grunert et al.) the process, which can be summarized with the overall reaction
Al₂O₃+3C=2Al+3CO (1)
takes place, or can be made to take place, in two steps:
2Al₂O₃+9C=Al₄C₃+6CO (2)
Al₄C₃+Al₂O₃=6Al+3CO (3).

Reaction (2) takes place at temperatures between 1900 and 2000° C. The actual aluminum producing reaction (3) takes place at temperatures of 2200° C. and above; the reaction rate increases with increasing temperature. In addition to the species stated in reactions (2) and (3), volatile Al species including Al₂O are formed in reactions (2) and (3) and are carried away with the off gas. Unless recovered, these volatile species represent a loss in the yield of aluminum. Both reactions (2) and (3) are endothermic.

Various attempts have been made to develop efficient production technology for the direct carbothermic reduction of alumina (cf. Marshall Bruno, Light Metals 2003, TMS (The Minerals, Metals & Materials Society) 2003). U.S. Pat. No. 3,607,221 (Kibby) describes a process in which all products quickly vaporize to essentially only gaseous aluminum and CO, containing the vaporous mixture with a layer of liquid aluminum at a temperature sufficiently low that the vapor pressure of the liquid aluminum is less than the partial pressure of the aluminum vapor in contact with it and sufficiently high to prevent the reaction of carbon monoxide and aluminum and recovering the substantially pure aluminum.

Other patents relating to carbothermic reduction to produce aluminum include U.S. Pat. No. 4,486,229 (Troup et al.) and U.S. Pat. No. 4,491,472 (Stevenson et al.). Dual reaction zones are described in U.S. Pat. No. 4,099,959 (Dewing et al.). More recent efforts by Alcoa and Elkem led to a novel two-compartment reactor design as described in U.S. Pat. No. 6,440,193 (Johansen et al.).

In the two-compartment reactor, reaction (2) is substantially confined to a low-temperature compartment. The molten bath of Al₄C₃ and Al₂O₃ flows under an underflow partition wall into a high-temperature compartment, where reaction (3) takes place. The thus generated aluminum forms a layer on the top of a molten slag layer and is tapped from the high-temperature compartment. The off-gases from the low-temperature compartment and from the high-temperature compartment, which contain Al vapor and volatile Al₂O are reacted in a separate vapor recovery units to form Al₄C₃, which is re-injected into the low-temperature compartment. The energy necessary to maintain the temperature in the low-temperature compartment can be provided by way of high intensity resistance heating such as through graphite electrodes submerged into the molten bath. Similarly, the energy necessary to maintain the temperature in the high-temperature compartment can be provided by a plurality of pairs of electrodes substantially horizontally arranged in the sidewalls of that compartment of the reaction vessel.

One of the requirements for graphite electrodes to be used in a vertical position in the low-temperature department in an aluminum carbothermic reduction furnace is a surface having low permeability to prevent leakage of the pressurized gaseous components from the furnace. Calculations indicate that a CO permeability of less than 10⁶ cm²/sec at the graphite surface will be required to keep the CO and also the less volatile gaseous Al and Al₂O in the furnace. Since commercially available graphite electrodes usually have permeabilities of several orders of magnitude higher than the required level, it is necessary to find some means for sealing the graphite surfaces.

Various methods to make graphite surfaces impervious to gases are being commonly used. However, the specific requirements of the aluminum carbothermic reduction furnace call for modifications of conventional surface sealing techniques. The prior art does not properly satisfy all of the requirements.

One specific limitation to the state-of-the-art coating is the specific temperature regime of the graphite electrode. The electrode is being consumed during furnace operation and thus electrode columns connected by graphite pins are fed in a continuous manner from the top into the furnace. Since the furnace atmosphere is about 2000° C. hot and the graphite electrode is a very good heat conductor, it has, despite additional external cooling measures, a temperature of up to 300° C. at the furnace compartment inlet. Thus, the electrode coating must sustain at least 300° C. over a period of several hours without oxidation. Furthermore, the coating will, at least partially, enter the furnace compartment where it may contaminate the hot melt. Hence, the chemistry of the coating materials should be similar to the ingredients of reaction (1) or at least the amount of foreign elements has to be very low. Of equal importance is the requirement for the coating not to increase the electrical contact resistance at the connection between the electrode columns and the electrode holding clamps to limit the energy losses. In addition, since the electrode inlet area will be constantly cooled by water, the coating needs to be non-soluble in water.

### SUMMARY OF THE INVENTION

It is accordingly an object of the invention to provide a gas-tight graphite electrode for a carbothermic reduction furnace which overcomes the above-mentioned disadvantages of the heretofore-known devices and methods of this general type and which is particularly suited for the production of aluminum by carbothermic reduction of alumina. The object is, in particular, to provide graphite electrodes which have been coated to make them gas impervious, where the coating can withstand temperatures of up to 300° C., barely contaminates the hot melt with impurities, does not have detrimental effects on the electrical contact resistance at the connection between the electrode columns and the electrode holding clamps, and is not dissolved by water.

With the foregoing and other objects in view there is provided, in accordance with the invention, graphite electrode for a furnace for producing aluminum by carbothermic reduction of alumina. The graphite electrode has a coating that renders a CO permeability of the electrode body less than 10⁻⁶ cm²/sec. Further the coating is substantially insoluble in water and/or its main constituents correspond to those found in the above equation (1).

In accordance with an added feature of the invention, the coating is configured to withstand temperatures of up to 300° C. and above for several hours substantially without oxidation.

In accordance with an additional feature of the invention, the coating is configured to no more than negligibly increase an electrical resistance of the electrode body at a holding region at which the electrode body is held by electrode clamps in the furnace.

In accordance with another feature of the invention, the coating is a thermally decomposed pyrolytic carbon coating, a glassy carbon coating, it is formed from a high-temperature-coked resin, it is a sodium silicate layer, or it is formed from metallic Al applied on an Al-containing pre-coating layer which, in a preferred embodiment, is formed by sol or gel coating a pre-coating layer of Si and Al.

With the above and other objects in view there is also provided, in accordance with the invention, a method of producing a graphite electrode for a furnace for producing aluminum by carbothermic reduction of alumina, which comprises:
providing a graphite electrode body; and
coating at least a part of the graphite electrode body to adjust a CO permeability thereof to less than 10⁻⁶ cm²/sec.

According to one embodiment of this invention, the electrode is coated with pyrolytic carbon employing thermal decomposition techniques. A further embodiment of this invention relates to sealing the electrode surface by coating it with glassy carbon. In another embodiment of this invention, the coating is obtained by applying resins with high-temperature coking behavior such as phenolic resin, novolak resin, formic aldehyde, and epoxy resin. It is a further embodiment of this invention to coat the electrodes with sodium silicate. In an even further embodiment of this invention the electrode coating is obtained by applying metallic Al on an Al-containing pre-coating layer. It is yet another embodiment of this invention to coat the electrodes with sols or gels based on Al or Al oxide particles, preferably with a Si and Al-containing pre-coating layer. Various combinations of these coating embodiments are equally possible as well.

One advantage of the above described coating techniques is that most of the particulate matter of the coating diffuses inside the graphite surface pores, thus forming only a thin film on the electrode surface which hardly influences the electrical surface contact properties of the electrode. Further, all described coating techniques can be applied at an industrial scale, thus adding little cost to the graphite electrodes. The thus coated electrodes can be safely used in aluminium carbothermic reduction furnaces without any CO escaping from the furnace atmosphere.

Other features which are considered as characteristic for the invention are set forth in the appended claims.

Although the invention is illustrated and described herein as embodied in a gas-tight electrode for a carbothermic reduction furnace, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of an exemplary implementation of the invention, including specific examples and embodiments of the invention.

### DETAILED DESCRIPTION OF AN EXEMPLARY EMBODIMENT

The following examples are presented to further illustrate and explain the present invention. They should not be viewed as limiting in any regard. Unless otherwise indicated, all parts and percentages are by weight.

Graphite electrodes used in electric arc furnaces for steel manufacturing have CO permeabilities in the range of 1 cm²/sec to 10³ cm²/sec depending on the choice of the raw material and the number of impregnation cycles. For the benefit of low product costs, one should preferably use graphite electrode grades with lower gas permeability.

In one embodiment of this invention, the graphite electrode surface is sealed by pyrolytic carbon deposited in its pores. The electrode is placed in a vacuum furnace, outgassed for less than 5 minutes by applying vacuum, followed by charging the evacuated volume with gaseous carbon-rich hydrocarbon compounds, such as acetylene, at a pressure of about 20 psig for less than 1 second, and heating the furnace to a temperature of 800 to 1000° C. in order to thermally decompose the gaseous hydrocarbon in the pores and convert the decomposed hydrocarbon to pyrolytic carbon. The volume evacuating and charging steps at the end of each of described sequence are successively and repetitively continued for 2 to 5 times.

In a further embodiment, CO gas permeability was reduced by coating the electrode with glassy carbon. The electrode was spray-coated with a solution of polyamic acid at room temperature and the solvent was evaporated at elevated temperatures of 70 to 100° C. followed by further raising the temperature to 400° C. for imidization. This procedure was repeated 4 times.

In another embodiment of this invention, the coating is obtained by applying resins with high-temperature coking behavior such as phenolic resin, novolak resin, formic aldehyde, or epoxy resin. The electrode is placed in a vacuum furnace, outgassed for less than 5 minutes by applying vacuum, followed by charging the evacuated volume with a resin, such as phenolic resin at a pressure of about 10 psig for less than 30 minutes, and heating the furnace to a temperature of 600 to 800° C. This converts the resin into carbon. Then, the volume evacuating and charging steps at the end of each described sequence are repeated in the same sequence for up to 4 times, each time reducing the resin charge time by 5 minutes.

It is a further embodiment of this invention to coat the electrodes with sodium silicate. The sodium silicate solution (15% by weight aqueous solution) is applied at a rate of 25 to 50 g/m² to the 60 to 75° C. hot electrode surface by spray coating. The sodium silicate coating is then dried in hot air at a temperature of 350°. This procedure may be repeated several times.

In an even further embodiment of this invention the electrode coating is obtained by plasma-spraying of Al. On the surface of a graphite electrode, a first layer consisting of aluminum with a technical grade purity in an amount of 700 g/m² was applied by plasma-spraying. Over this layer aluminum layer, a blend with: 35 g/m² iron oxide, 10 g/m² nickel, and 18 g/m² aluminum powder was applied. This was followed by heat treatment with a surface density of the heat flow of 12 times 10⁶ W/cm², thus alloying the two layers to form an Al—Fe—Ni layer. This procedure was repeated once more. Finally, a layer of pure aluminum in the amount of 1150 g/m² was applied by metallization.

In another embodiment, Al or Al oxide particles in form of sols or gels are applied to the surface of the electrode. From the various commercially available products, it is preferred to use those with very small particle sizes, preferable in the range of less than 100 nm. The best results are achieved by applying a pre-coating layer based on 2 to 5% silicon in aluminum by a conventional technique such as painting, spraying, rolling, or dipping the carbon substrate into a colloidal-like suspension containing both elements. The aluminum-silicon coated electrode is then subjected to a heat treatment in an inert gas atmosphere at about 900° C. for about 30 min, wherein silicon carbide is formed in situ as an interfacial layer which serves to chemically bond the aluminum to the carbon. Afterwards, the colloidal Al or alumina particles were applied by painting or spraying and the thus covered electrode was briefly heated in inert gas atmosphere to 900° C. for about 10 minutes.

The electrode surface may also be sealed by using combinations of the above-described coating techniques.

The graphite electrode treated in the above described manner had a CO permeability of less than 10⁻⁶ cm²/sec.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

1. In a furnace for producing aluminum by carbothermic reduction of alumina, a graphite electrode comprising a shaped graphite electrode body and a coating on said electrode body, said coating defining a CO permeability of said electrode body to less than 10⁻⁶ cm²/sec and being substantially insoluble in water.

2. The graphite electrode according to claim 1, wherein said coating is configured to withstand temperatures of up to 300° C. and above for several hours substantially without oxidation.

3. The graphite electrode according to claim 1, wherein said coating is configured to no more than negligibly increase an electrical resistance of said electrode body at a holding region at which said electrode body is held by electrode clamps in the furnace.

4. The graphite electrode according to claim 1, wherein said coating is configured not to contaminate a melt in the furnace containing alumina, aluminum carbide, carbon, and carbon monoxide.

5. The graphite electrode according to claim 1, wherein said coating is a thermally decomposed pyrolytic carbon coating.

6. The graphite electrode according to claim 1, wherein said coating is a glassy carbon coating.

7. The graphite electrode according to claim 1, wherein said coating is formed from a high-temperature-coked resin.

8. The graphite electrode according to claim 1, wherein said coating is formed of phenolic resin, novolak resin, formic aldehyde, or epoxy resin.

9. The graphite electrode according to claim 1, wherein said coating is a sodium silicate layer.

10. The graphite electrode according to claim 1, wherein said coating is formed from metallic Al applied on an Al-containing pre-coating layer.

11. The graphite electrode according to claim 1, wherein said coating is formed from a sol or gel coating layer based on Al or Al oxide particles.

12. A method of producing a graphite electrode for a furnace for producing aluminum by carbothermic reduction of alumina, which comprises:
providing a graphite electrode body; and
coating at least a part of the graphite electrode body to adjust a CO permeability thereof to less than 10⁻⁶ cm²/sec.

13. The method according to claim 12, which comprises coating the electrode body with pyrolytic carbon employing thermal decomposition techniques.

14. The method according to claim 12, which comprises coating the electrode body with glassy carbon.

15. The method according to claim 12, which comprises forming a coating by applying resins with high-temperature coking behavior on the electrode body, and coking the resins to form a substantially CO-impermeable coating.

16. The method according to claim 12, which comprises coating the electrode body with sodium silicate.

17. The method according to claim 12, which comprises coating the electrode body with an Al-containing pre-coating layer and applying metallic Al on the pre-coating layer.

18. The method according to claim 12, which comprises applying a sol or a gel based on Al or Al oxide particles on the electrode body.

19. The method according to claim 18, which comprises, prior to the applying step, applying a pre-coating layer based on 2 to 5% silicon in aluminum, and subsequently heat-treating the electrode in an inert atmosphere to approximately 900° C.

20. In a furnace for producing aluminum by carbothermic reduction of alumina, a graphite electrode comprising a shaped graphite electrode body and a coating on said electrode body for reducing a CO permeability of said electrode body to less than 10⁻⁶ cm²/sec, said coating having a major constituent element selected from the group consisting of Al and C.
